(19) United States
(12) Patent Application Publication
(10) Pub. No.: US 2026/0111328 A1
(43) Pub. Date: Apr. 23, 2026

(54) FAST AGGREGATION FUNCTIONALITY FOR REAL-TIME ANALYSIS

(71) Applicant: SAP SE, Walldorf (DE)

(72) Inventors: Sebastian Mietke, Reilingen (DE); David Bischof, Wiesloch (DE); Thomas Mietke, Wiesloch (DE)

(21) Appl. No.: 18/921,326

(22) Filed: Oct. 21, 2024

(51) Int. Cl. G06F 11/30; G06F 11/32

(52) U.S. Cl. CPC G06F 11/3082; G06F 11/328

(57) ABSTRACT

A first request is received from an analysis application to aggregate data of a given data source. In response to receiving the first request, new data is retrieved from the given data source and historical data is retrieved from a persistent data source corresponding to the given data source. Also, only the new data from the given data source is aggregated. Next, the historical data is combined with the aggregated new data in a first proxy data source. Then, the first proxy data source is provided as an input to the analysis application. Next, a view is generated of results of an analysis of the first proxy data source and the view is displayed in a user interface on a first computing device.

### TECHNICAL FIELD

The present disclosure generally relates to implementing fast aggregation functionality to extract key performance indicators for real-time analysis.

### BACKGROUND

Analysis capabilities are crucial for software systems. Especially, real-time monitoring is becoming more important nowadays. In real-time monitoring, data is condensed to reflect the key information of the live software system. In case of huge data volumes, this might be difficult. Even modern technologies like current in-memory database systems come to their limits if the data volume is large enough. This results in subpar performance of the analysis application.

### SUMMARY

In some implementations, a first request is received from an analysis application to aggregate data of a given data source. In response to receiving the first request, new data is retrieved from the given data source and historical data is retrieved from a persistent data source corresponding to the given data source. Also, only the new data from the given data source is aggregated. Next, the historical data is combined with the aggregated new data in a first proxy data source. Then, the first proxy data source is provided as an input to the analysis application. Next, a view is generated of results of an analysis of the first proxy data source and the view is displayed in a user interface on a first computing device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a logical block diagram of a database system, in accordance with some example implementations of the current subject matter;

FIG. 3 illustrates a diagram of a data model of an example application, in accordance with some example implementations of the current subject matter;

FIG. 4 illustrates a block diagram of functionality for implementing fast aggregation capability for real-time analysis, in accordance with some example implementations of the current subject matter;

FIG. 5 illustrates a diagram of a new data model used by an analysis application, in accordance with some example implementations of the current subject matter;

FIG. 6 illustrates an example of a process for performing object generation for fast aggregation, in accordance with some example implementations of the current subject matter;

FIG. 7 illustrates an example of a process for filling a new aggregation table, in accordance with some example implementations of the current subject matter;

FIG. 8 illustrates an example of a process for responding to a request from an analysis application to aggregate data of an original data source, in accordance with some example implementations of the current subject matter;

FIG. 9 illustrates an example of a process for aggregating data as part of an analysis operation, in accordance with some example implementations of the current subject matter;

FIG. 10A depicts an example of a system, in accordance with some example implementations of the current subject matter; and

FIG. 10B depicts another example of a system, in accordance with some example implementations of the current subject matter.

### DETAILED DESCRIPTION

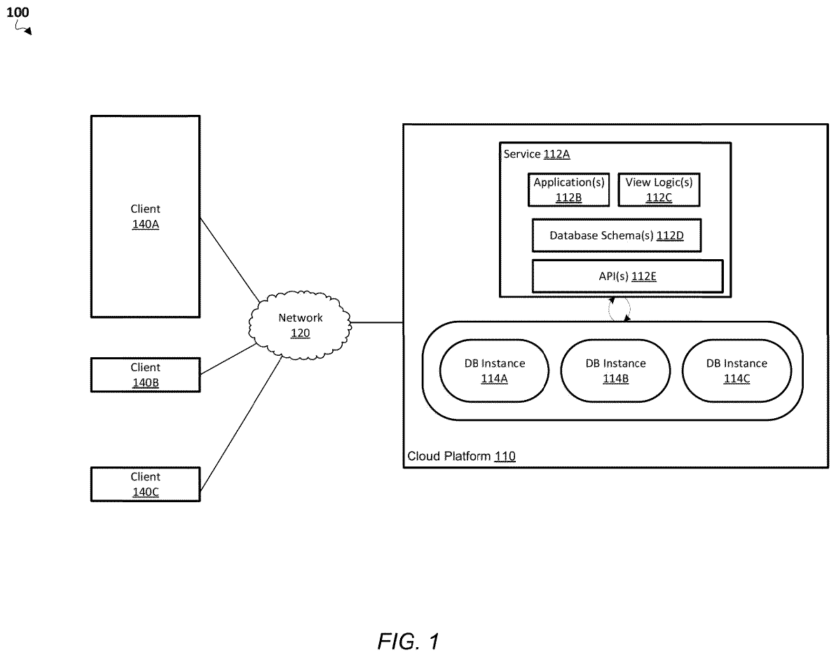

FIG. 1 depicts a diagram illustrating an example of a system 100 consistent with some implementations of the current subject matter. Referring to FIG. 1, the system 100 may include a cloud platform 110. The cloud platform 110 may provide resources that can be shared among a plurality of tenants. For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

In the example of FIG. 1, the system 100 includes a first tenant 140A (labeled client), a second tenant 140B, and a third tenant 140C, although cloud platform 110 may have other quantities of tenants. The clients may each comprise a user device (e.g., a computer including an application such as a browser or other type of application). The user device may be a processor-based device including, for example, a smartphone, a tablet computer, a wearable apparatus, a virtual assistant, an Internet-of-Things (IoT) appliance, and/or the like. Each client may access, via network 120, at least one of the services at the cloud platform 110. In some implementations, each of the tenants 140A-C represents a separate tenant at the cloud platform 110, such that a tenant's data is not shared with other tenants (absent permission from a tenant). Alternatively, each of the tenants 140A-C may represent a single tenant at the cloud platform 110, such that the tenants do share a portion of the tenant's data, for example.

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources. In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client (e.g., the first tenant 140A). This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client such as first tenant 140A). To illustrate further, the client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database instance 114A may be accessed as a service at a cloud platform, which may be the same or different platform from cloud platform 110. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premise) and/or another cloud platform.

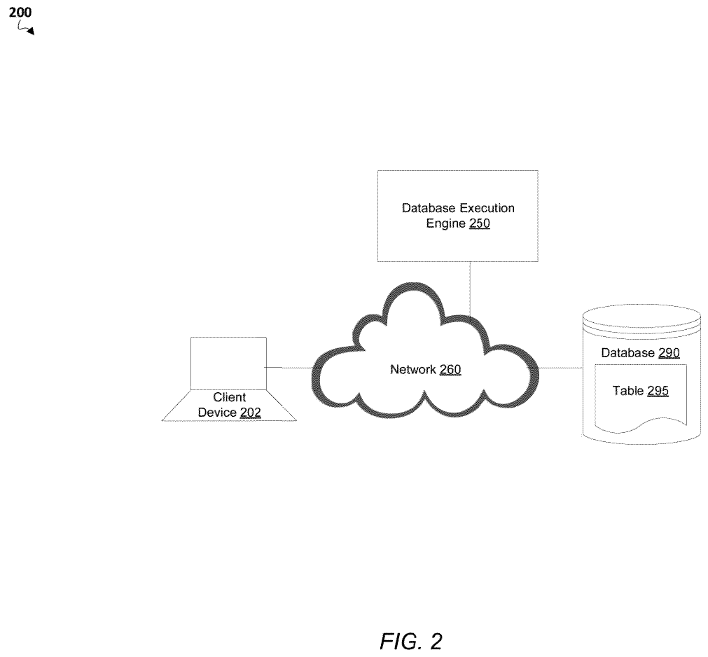

Turning now to FIG. 2, a system diagram illustrating an example of a database system 200 is shown, in accordance with one or more embodiments of the current subject matter. Referring to FIG. 2, the database system 200 may include one or more client devices 202, a database execution engine 250, and one or more databases 290. As shown in FIG. 2, the one or more client devices 202, the database execution engine 250, and the one or more databases 290 may be communicatively coupled via a network 260. The one or more databases 290 may include a variety of relational databases including, for example, an in-memory database, a column-based database, a row-based database, and/or the like. The database execution engine 250 may store a database table 295 at the one or more databases 290, with the database table 295 representative of any number and type of tables.

In some example embodiments, the one or more databases 290 may include a relational database. However, it should be appreciated that the one or more databases 290 may include any type of database including, for example, an in-memory database, a hierarchical database, an object database, an object-relational database, and/or the like. For example, instead of and/or in addition to including a relational database, the one or more databases 290 may include a graph database, a column store, a key-value store, a document store, and/or the like.

The one or more client devices 202 may include processor-based devices including, for example, a mobile device, a wearable apparatus, a personal computer, a workstation, an Internet-of-Things (IoT) appliance, and/or the like. The network 260 may be a wired network and/or wireless network including, for example, a public land mobile network (PLMN), a local area network (LAN), a virtual local area network (VLAN), a wide area network (WAN), the Internet, and/or the like.

To illustrate by way of an example, a given client device 202 may send a query via the database execution engine 250 to the database layer including the one or more databases 290, which may represent a persistence and/or storage layer where database tables may be stored and/or queried. Furthermore, the database execution engine 250 may provide the ability to access table storage via an abstract interface to a table adapter, which may reduce dependencies on specific types of storage and persistence layers, which may in turn enable use with different types of storage and persistence layers.

The database execution engine 250 may be configured to handle different types of databases and the corresponding persistent layers and/or tables therein. The database execution engine 250 may perform operations including rule-based operations, such as joins and projections, as well as filtering, group by, multidimensional analysis, and/or the like in such a manner so as to reduce the processing burden on the database layer. In this way, the database execution engine 250 may execute these and other complex operations, while the one or more databases 290 can perform simpler operations to reduce the processing burden at the one or more databases 290.

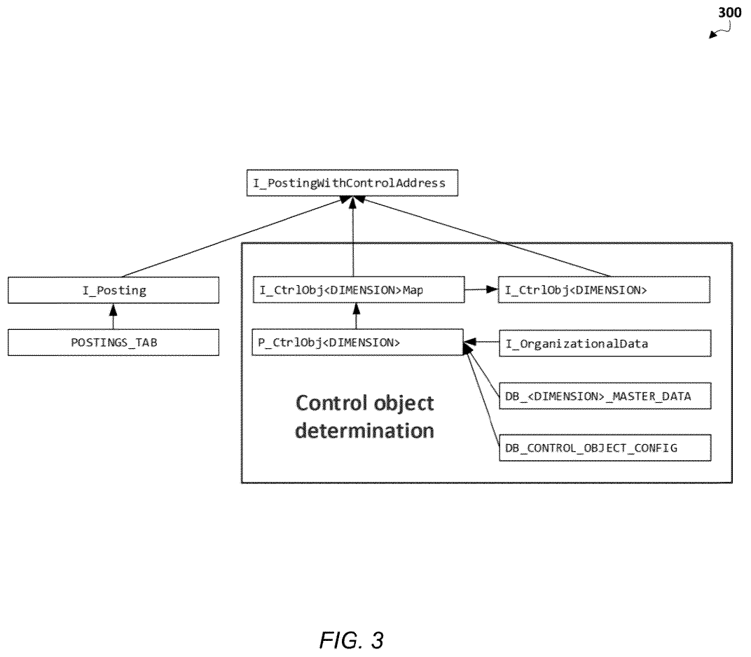

Referring now to FIG. 3, a diagram of an example of a data model 300 of an example application is depicted, in accordance with one or more embodiments of the current subject matter. The example of data model 300 has been simplified for ease of discussion. Nevertheless, the described approach may also be applied for complex examples.

A new analysis application may be introduced to show aggregated posting amounts from the posting table POSTINGS_TAB. The aggregation is performed based on user specific settings (based on shown fields on the user interface) and based on authorizations of the user. The user may request analysis on parts of a control address. In an example, the control address is a set of up to ten fields derived at runtime. Each field of the control address is called a control object. The control objects are derived from the account assignments of the posting. Additionally, multiple configuration options may be evaluated, to retrieve the correct control object for each account assignment and hence the control address. Different combinations of account assignments might lead to the same control address. The same combination of account assignments always leads to the same control address. The derivation process may be performed in a core data services (CDS) view stack. Complex table functions may be involved. The results may be exposed through the interface CDS view I_PostingWithControlAddress.

In various embodiments, a table may consist of millions of posting table entries. For each entry, a control address may be calculated. The control address is an abstract entity based on a calculated field or on a set of fields which may be calculated for each posting. Later on, the system may aggregate data based on this control address. This aggregated data will include all postings which belong to the same control address. Unfortunately, the data cannot be filtered in advance because it is not known which postings go with which control address. Therefore, it is necessary to calculate all control addresses for each line within the posting data table, and later on, the data may be grouped and filtered. Accordingly, first, each line in the table will be processed. This means, whenever the corresponding analysis application is opened, the control address will be calculated for each posting in the system. Later on, this data may be aggregated and filtered. This is time-consuming and unnecessary because the control address remains the same for the posting. If the analysis application is opened again ten minutes later, and the same posting is processed, then the same control address will be derived.

In some cases, the control address might change. This could be caused by some configuration changes, changes to the master data object, and so on. This is why the original posting table cannot be enhanced with the control address data. Instead, the control address data will be calculated in real-time. Typically, changes in the configuration happen infrequently. In an example, a periodic job may run in the background to update this information. Then, if there is an inconsistency in the data, the inconsistency will only be for the amount of time since the last periodic job was run, which will typically be a relatively short duration of time. Accordingly, a persistency of the aggregated data may be generated, which is refreshed periodically.

For this example, it is assumed that only new data may be inserted to the original data source. In other words, for the example of data model 300 of FIG. 3, only new postings are created in POSTINGS_TAB. If an existing posting is to be changed, a follow-up posting may be created instead of updating the existing posting (INSERT-only approach). Furthermore, it is assumed that new postings can be identified by a timestamp field. As an example, there might be the field CREATED_AT, containing a timestamp from when the posting was created.

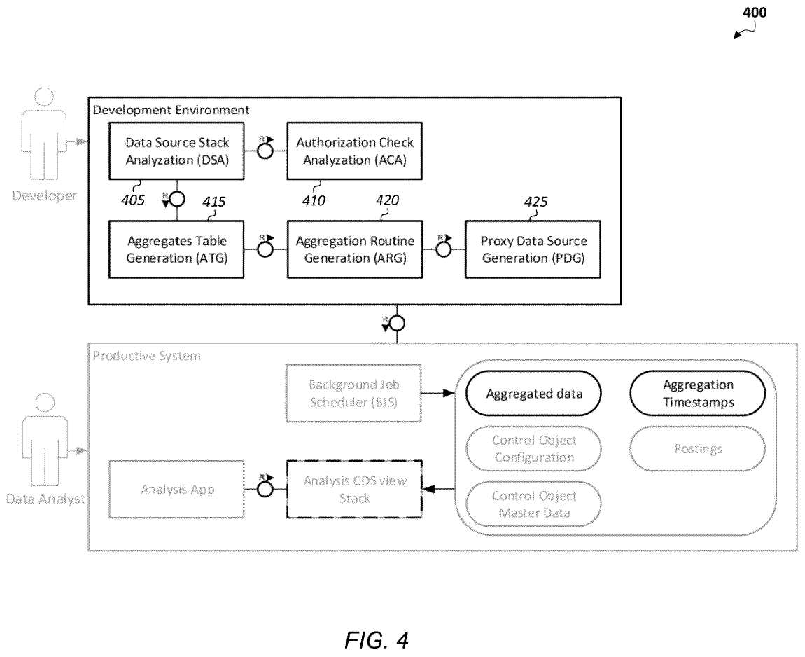

Turning now to FIG. 4, a block diagram of functionality 400 for implementing fast aggregation capability for real-time analysis, in accordance with one or more embodiments of the current subject matter. Depending on the embodiment, functionality 400 may be implemented as a plug-in or as a dedicated application. For example, functionality 400 may be a plug-in for the development environment along with some additional components. Alternatively, functionality 400 may be implemented as a dedicated service.

In an example, the developer for an analysis application provides the view name of the original data source. In the example of FIG. 3, the original data source is the interface CDS view I_PostingWithControlAddress. Again, this CDS view and its subsidiary CDS views retrieve the posting information joined with the information for all control objects. The developer may also provide a set of fields to be used for the aggregation. For example, the developer may provide the dimensions of the control address or the control objects. Later, the developer may want to aggregate data at the control address level.

Next, the corresponding tables which will be consumed are analyzed by the system. For example, data source stack analyzation (DSA) unit 405 derives the entities that have to be considered, which means all of the underlying database tables. The aggregation may be based on authorizations. One end user may have the authorization to view all of the data, but a second end user may only have the authorization to view the data for a specific control address or a specific master data object used within the posting. Therefore, the authorization check analyzation (ACA) unit 410 may enhance the set of fields provided by the developer with all fields that might be relevant for authorization checks.

If there is an authorization check on a specific field (e.g., a specific master data field), this field will be considered as a key field for the new aggregates persistency, because the system will distinguish between different master data object instances. For one instance, the user might have authorization, while for another other instance, the user might not have authorization. The table would have an additional key column and only the corresponding values for which the user has authorization. If the user has all authorizations for all data values, then all data values can be picked. If the user only has authorization for master data A, then only entries for master data A are picked. The ACA unit 410 analyzes the underlying authorization checks and enhances the set of fields that were initially provided by the developer by all authorization check relevant fields.

Now, once the overall set of fields for the aggregation table have been generated, the table is generated for storing the aggregates. In an example, this may be performed by the aggregates table generation (ATG) unit 415. To fill this table, a routine may be performed. The routine may be generated from a template by aggregation routine generation (ARG) unit 420. During this routine, the original data model is evaluated, and the aggregation is performed accordingly. And if the data has been aggregated from the original data model, then the results are used to fill the new database table.

In an example, the routine might be planned as a periodic job by a background job scheduler. In this example, the content of the aggregation table may be updated on a particular interval (e.g., hourly). Different approaches might be followed. As an example, the aggregation table might be cleared during each run of the background job. Afterwards, the overall data is aggregated again and the results are stored in the aggregation table. In this way, potential inconsistencies might be corrected automatically (e.g., every hour). Alternatively, only the data created after the previous background job run might be considered. This might have a positive effect on the runtime of the job. In any event, the content of the aggregation table will be refreshed according to the periodicity of the background job.

In an example, each job run updates the aggregation timestamp repository with the information from the defined timestamp field. In this case, the latest timestamp in the field CREATED_AT of the processed postings from POSTINGS_TAB is stored in the repository. This latest timestamp TS_LATEST can be retrieved from the repository, by providing the name of the original data source. In this example, the postings with CREATED_AT less than or equal to TS_LATEST are historical data. The postings with CREATED_AT greater than TS_LATEST are new data.

In an example, proxy data source generation unit 425 creates a new proxy data source (e.g., CDS view) which combines the aggregate information with the new posting information. The new proxy data source picks the historical data, which is the persisted aggregated data from the new table that was generated and filled. The new proxy data source also considers the union of the original data model but only for data that has been posted since the most recent update. In other words, this is only for the delta (i.e., the new data). So the new proxy data source goes through the original data model but only for the delta. This means that the control addresses are calculated again, not for all of the data, but instead for only a relatively small fraction of the data.

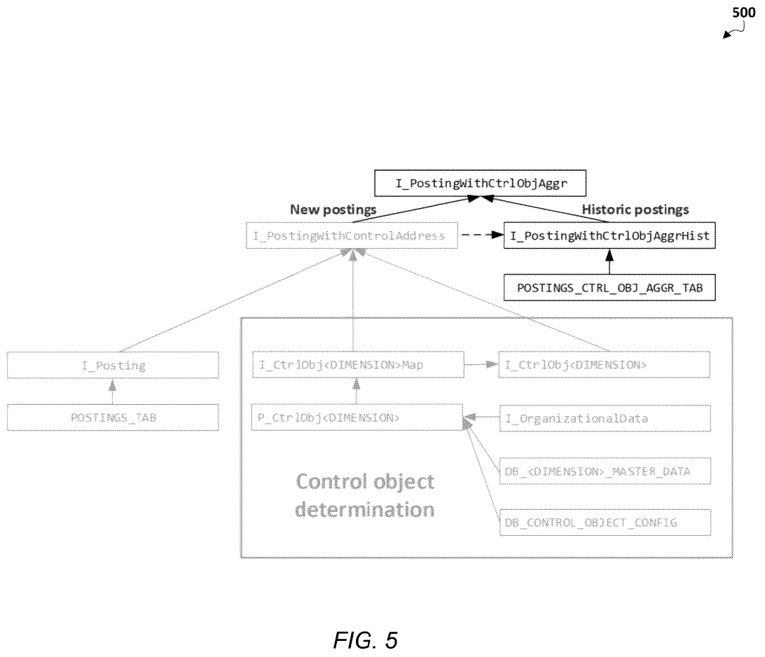

In an example, the proxy data source might be reflected by a new CDS view generated from a template. A suitable name might be provided by the developer (e.g., I_PostingWithCtrlObjAggr). In general, a UNION is performed to retrieve historical data (already aggregated by the background job) from the aggregation table and new data (to be aggregated by the proxy data source) from the original data source through the original data model. The new data model 500 used by the analysis application is adjusted as shown in FIG. 5.

If there is a relatively large number of postings, this would traditionally require calculating the control address for this large number of postings. But with the hybrid approach described herein, the aggregate exists which already contains the control address for each aggregated entry. And the control address is only calculated for new postings, which may be a fraction of the overall postings. This is why the execution of the overall view is much faster, because the process entries are reduced to a relatively small number of postings. As a result of these productivity gains, the total cost of ownership for users may be reduced.

In an example, this process may be performed on-demand. When the analysis application is used again, then this delta handling happens on-demand instead of by a job running periodically. Each time the analysis application is executed, an update can be considered to the aggregate statement. There are different possibilities for the customization. In an example, the determination of whether to perform the delta handling on-demand or by a periodically running job may be made at runtime. The determination may be based on operating conditions, such as processor utilization, memory utilization, bandwidth constraints, execution thread count, and so on.

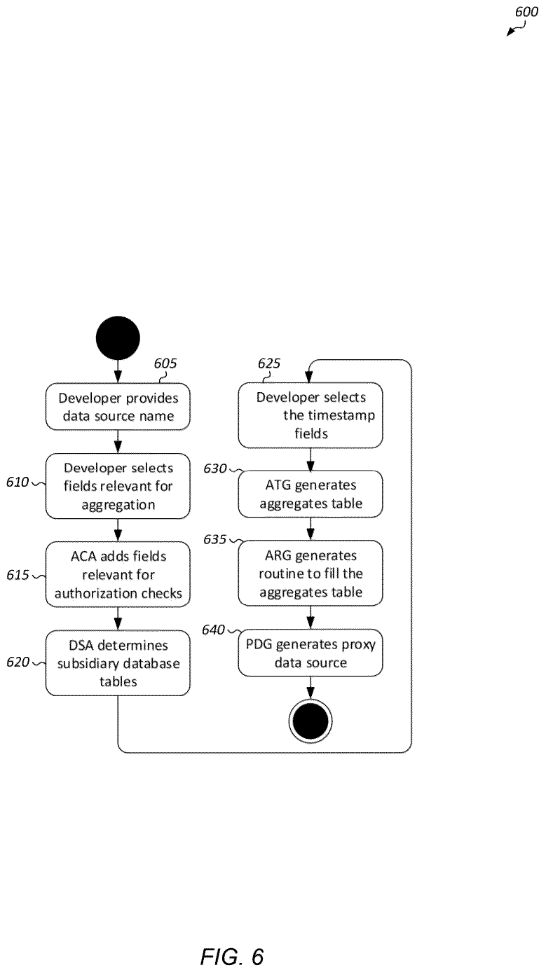

Turning now to FIG. 6, a process for performing object generation for fast aggregation is depicted, in accordance with one or more embodiments of the current subject matter. The developer provides a name of an original data source (block 605). In an example, the original data source is a CDS view. Next, the developer selects field relevant for aggregation (block 610). In an example, all fields for the control objects are provided since the user will later analyze the posting amounts on the control address level. These fields will then be used as key fields for the new aggregation table. Also, non-key fields to be aggregated may be specified as well. These fields will then be added as non-key fields for the new aggregation table. It is noted that the terms “aggregation table” and “aggregates table” may be used interchangeably herein.

Then, an authorization check analysis (ACA) unit adds fields relevant for authorization checks (block 615). To enable authorization checks, the list of key fields may be enhanced by all authorization-relevant fields. In an example, there might be an authorization check on the field AUTH_REL of POSTINGS_TAB. Since the user should only have access to data for which the user is authorized, the aggregated posting amount depends on the user's authorization. Therefore, the field AUTH_REL may be added as a grouping criterion for the aggregation key field. The authorization relevant fields may be added automatically by the ACA unit. In an example, the ACA unit analyses the access control of the corresponding interface CDS view I_PostingWithControlAddress to find these fields.

Next, the data source stack analysis (DSA) unit determines subsidiary database tables (block 620). In an example, multiple configuration tables, master data tables, and the table POSTINGS_TAB are determined. In an example, the subsidiary database tables may be determined through an analysis of the source code of the CDS view I_PostingWithControlAddress (and subsidiary CDS views).

Then, the developer selects the timestamp fields of entries for the corresponding database tables (block 625). The developer specifies fields containing a timestamp to allow the identification of new entries for the corresponding database tables. In an example, only the field CREATED_AT of the table POSTINGS_TAB is specified by the developer. This means, that all other information (master data, configuration) may be considered as constant for simplicity reasons. Consequently, the results of the aggregation can only be altered by new postings. In an example, this step might be supported by machine learning (ML) techniques. As an example, it might be known from previous use cases, that CREATED_AT is commonly used, so this field can be proposed automatically.

Next, the aggregates table generation (ATG) unit generates an aggregates table (block 630). The ATG unit may create a new database table according to the fields specified by the developer and determined by the ACA unit for storing aggregated data. The name of the database table might be provided by the developer (e.g., POSTINGS_CTRL_OBJ_AGGR_TAB). Alternatively, the name of the database table may be randomly generated. Then, the aggregation routine generation (ARG) unit generates a routine to fill the aggregates table (block 635). The routine may be an executable object, with the routine being executed to fill the newly generated aggregates table with aggregated data. Such an executable object might be a method of a class, a function module, or the like. The corresponding source code might be generated from a generic template. Finally, the proxy data source generation (PDG) unit generates a proxy data source (i.e., a new data source) to retrieve the combination of historic data and new data (block 640). In an example, the proxy data source might be reflected by a new database view (e.g., a new CDS view) generated from a template. Also, a suitable name may be provided by the developer (e.g., I_PostingWithCtrlObjAggr). After block 640, method 600 may end.

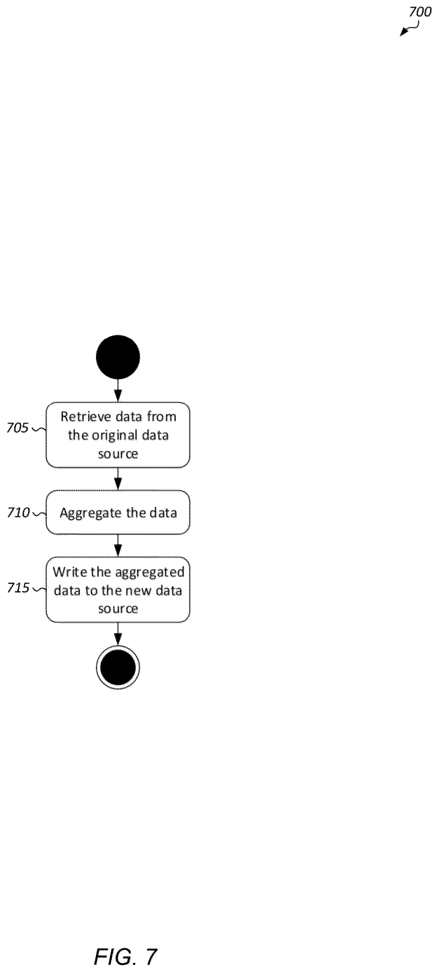

Referring now to FIG. 7, a process is depicted for filling a new aggregation table, in accordance with one or more embodiments of the current subject matter. At the beginning of the process, data is retrieved from an original data source (block 705). This may be the new data that has been added to the original data source since the last update to the persisted aggregation table. Next, the data is aggregated (block 710). For example, aggregating the data may involve deriving the control objects for each new data entry. Then, the aggregated data is written to the new data source (e.g., a newly generated database table) (block 715). After block 715, method 700 may end.

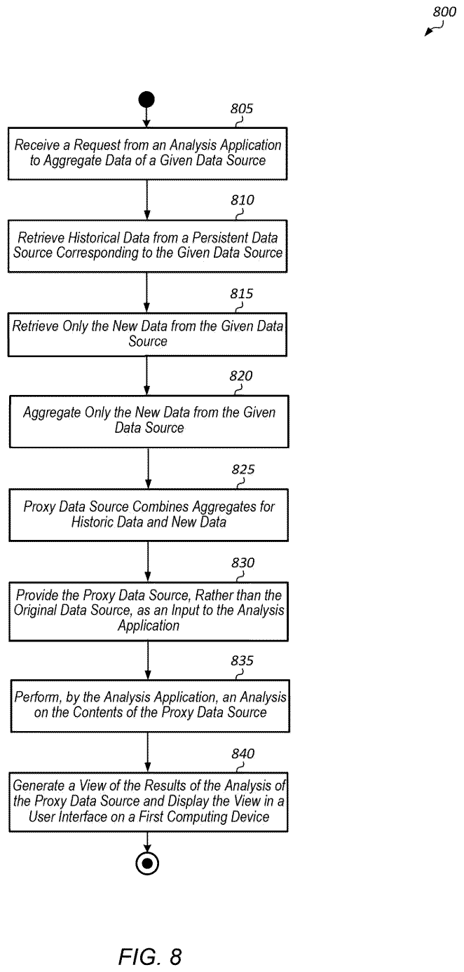

Turning now to FIG. 8, a process is depicted for responding to a request from an analysis application to aggregate data of an original data source, in accordance with one or more embodiments of the current subject matter. At the beginning of the process, a request is received from an analysis application to aggregate data of a given data source (block 805). In response to receiving the request, rather than retrieving all of the data from the given data source, historical data is retrieved from a persistent data source corresponding to the given data source (block 810). Then, only the new data is retrieved from the given data source (block 815). As used herein, the term “new data” refers to newly created data or newly posted data. In an example, the new data is identified based on a timestamp field, which is compared to the time of the last update to the persistent data source to identify new entries in the given data source. Next, only the new data from the given data source is aggregated (block 820). This is done by the proxy data source, which combines the previously aggregated historic data from the aggregation table with the new data aggregated at runtime of the analysis application (block 825) In an example, the proxy data source is a UNION of the aggregation table and the original data source (e.g., the given data source). Next, the proxy data source, rather than the given data source, is provided as an input to the analysis application (block 830). In other words, the proxy data source is provided in place of the given data source to the analysis application. Then, the analysis application performs an analysis on the contents of the proxy data source (block 835). It is noted that the analysis application may perform any type of analysis on the proxy data source, with the type of analysis varying from embodiment to embodiment. Then, a view is generated of the results of the analysis of the proxy data source and the view is displayed in a user interface on a first computing device (block 840). After block 840, method 800 may end. Additionally, one or more actions may be performed as a result of the analysis of the aggregation table. The one or more actions may include generating one or more electronic messages, performing updates to one or more database tables, launching one or more software applications, changing the settings of one or more computer systems, and so on. In some embodiments, at the end of method 800, the aggregation table may be used to overwrite the persistent data source, and the overwritten persistent data source may be used by subsequent requests to aggregate data of the given data source.

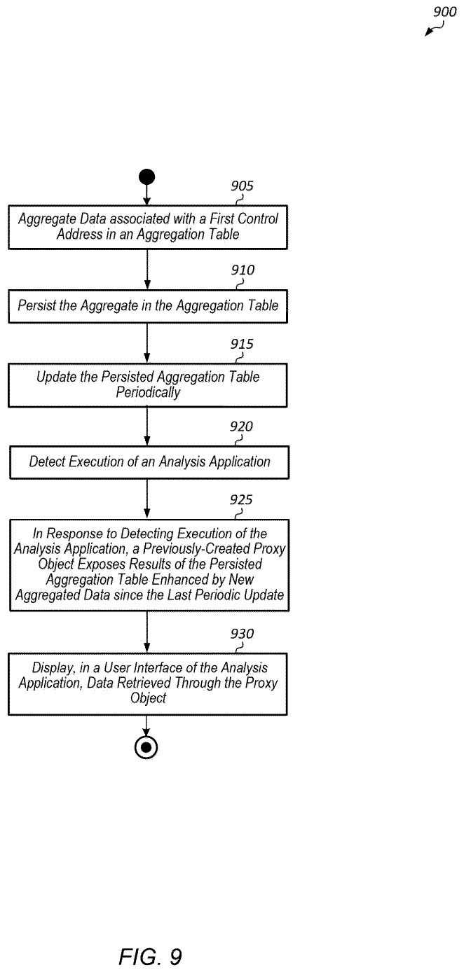

Turning now to FIG. 9, a process is depicted for aggregating data as part of an analysis operation, in accordance with one or more embodiments of the current subject matter. Data associated with a first control address is aggregated in an aggregation table (block 905). The first control address is a set of fields that are derived at runtime, and each field of the control address is referred to as a control object. The control objects may be derived from the account assignments of a corresponding table. Next, the aggregate is persisted in the aggregation table (block 910). Also, the persisted aggregation table may be updated periodically (block 915). Then, at a later point in time, execution of an analysis application is detected (block 920). In response to detecting execution of the analysis application, a previously-created proxy object exposes results of the persisted aggregation table enhanced by new aggregated data since the last periodic update (block 925). It is noted that the terms “proxy object” and “proxy data source” may be used interchangeably herein. Next, a user interface (UI) of the analysis application displays data retrieved through the proxy object (block 930). After block 930, method 900 may end.

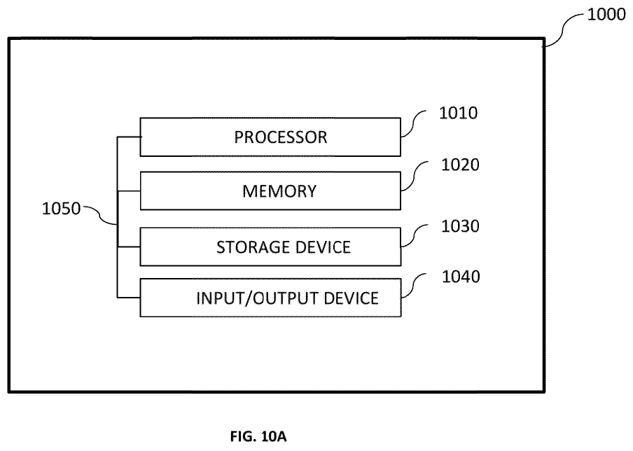

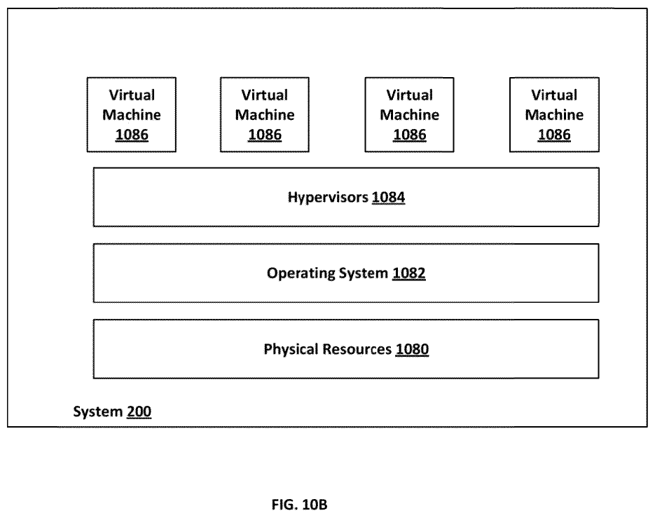

In some implementations, the current subject matter may be configured to be implemented in a system 1000, as shown in FIG. 10A. The system 1000 may include a processor 1010, a memory 1020, a storage device 1030, and an input/output device 1040. Each of the components (e.g., the processor 1010, the memory 1020, the storage device 1030, the I/O device 1040) may be interconnected using a system bus 1050. The processor 1010 may be configured to process instructions for execution within the system 1000. In some implementations, the processor 1010 may be a single-threaded processor. In alternate implementations, the processor 1010 may be a multi-threaded processor. The processor 1010 may be further configured to process instructions stored in the memory 1020 or on the storage device 1030, including receiving or sending information through the input/output device 1040. The memory 1020 may store information within the system 1000. In some implementations, the memory 1020 may be a computer-readable medium. In alternate implementations, the memory 1020 may be a volatile memory unit. In yet some implementations, the memory 1020 may be a non-volatile memory unit. The storage device 1030 may be capable of providing mass storage for the system 1000. In some implementations, the storage device 1030 may be a computer-readable medium. In alternate implementations, the storage device 1030 may be a floppy disk device, a hard disk device, an optical disk device, a tape device, non-volatile solid state memory, or any other type of storage device. The input/output device 1040 may be configured to provide input/output operations for the system 1000. In some implementations, the input/output device 1040 may include a keyboard and/or pointing device. In alternate implementations, the input/output device 1040 may include a display unit for displaying graphical user interfaces.

FIG. 10B depicts an example implementation of the system 200 (of FIG. 2). The system 200 may be implemented using various physical resources 1080, such as at least one or more hardware servers, at least one storage, at least one memory, at least one network interface, and the like. The system 200 may also be implemented using infrastructure, as noted above, which may include at least one operating system 1082 for the physical resources 1080 and at least one hypervisor 1084 (which may create and run at least one virtual machine 1086). For example, each multitenant application may be run on a corresponding virtual machine 1086.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable storage medium” refers to any computer program product, apparatus and/or device, such as for example magnetic discs, optical disks, memory, and Programmable Logic Devices (PLDs), used to provide machine instructions and/or data to a programmable processor, including a machine-readable storage medium that receives program instructions as a machine-readable signal. The term “machine-readable signal” refers to any signal used to provide machine instructions and/or data to a programmable processor. The machine-readable storage medium can store such program instructions non-transitorily, such as for example as would a non-transient solid state memory or a magnetic hard drive or any equivalent storage medium. The machine-readable storage medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A system comprising: at least one processor; and at least one memory storing instructions that, when executed by the at least one processor, cause operations comprising: receiving, from an analysis application, a first request to aggregate data of a given data source; in response to receiving the first request, retrieving new data from the given data source and retrieving historical data from a persistent data source corresponding to the given data source; aggregating only the new data from the given data source; combining the historical data with the aggregated new data in a first proxy data source; providing the first proxy data source as an input to the analysis application; and generating a view of results of an analysis of the first proxy data source and displaying the view in a user interface on a first computing device.
Example 2: The system of Example 1, wherein the operations further comprise overwriting the given data source with the first proxy data source.
Example 3: The system of any of Examples 1-2, wherein the operations further comprise: receiving, from the analysis application, a second request to aggregate data of the given data source; in response to receiving the second request, retrieving second new data from the given data source and retrieving second historical data from the overwritten given data source; aggregating only the second new data from the given data source; combining the second historical data with the aggregated second new data in a second proxy data source; and providing the second proxy data source as an input to an analysis application.
Example 4: The system of any of Examples 1-3, wherein the operations further comprise overwriting the given data source with the second proxy data source.
Example 5: The system of any of Examples 1-4, wherein the operations further comprise determining one or more subsidiary database tables associated with the given data source.
Example 6: The system of any of Examples 1-5, wherein the historical data is stored in a first aggregation table.
Example 7: The system of any of Examples 1-6, wherein the operations further comprise adding, by an authorization check analysis unit, one or more fields to the first aggregation table, wherein the one or more fields are relevant for authorization checks.
Example 8: The system of any of Examples 1-7, wherein the operations further comprise generating a routine to fill the first aggregation table.
Example 9: A computer-implemented method comprising: receiving, from an analysis application, a first request to aggregate data of a given data source; in response to receiving the first request, retrieving new data from the given data source and retrieving historical data from a persistent data source corresponding to the given data source; aggregating only the new data from the given data source; combining the historical data with the aggregated new data in a first proxy data source; providing the first proxy data source as an input to the analysis application; and generating a view of results of an analysis of the first proxy data source and displaying the view in a user interface on a first computing device.
Example 10: The computer-implemented method of Example 9, further comprising overwriting the given data source with the first proxy data source.
Example 11: The computer-implemented method of any of Examples 9-10, further comprising: receiving, from the analysis application, a second request to aggregate data of the given data source; in response to receiving the second request, retrieving second new data from the given data source and retrieving second historical data from the overwritten given data source; aggregating only the second new data from the given data source; combining the second historical data with the aggregated second new data in a second proxy data source; and providing the second proxy data source as an input to an analysis application.
Example 12: The computer-implemented method of any of Examples 9-11, further comprising overwriting the given data source with the second proxy data source.
Example 13: The computer-implemented method of any of Examples 9-12, further comprising determining one or more subsidiary database tables associated with the given data source.
Example 14: The computer-implemented method of any of Examples 9-13, wherein the historical data is stored in a first aggregation table.
Example 15: The computer-implemented method of any of Examples 9-14, further comprising adding, by an authorization check analysis unit, one or more fields to the first aggregation table, wherein the one or more fields are relevant for authorization checks.
Example 16: The computer-implemented method of any of Examples 9-15, further comprising generating a routine to fill the first aggregation table.
Example 17: A non-transitory computer readable storage medium storing instructions, which when executed by at least one data processor, result in operations comprising: receiving, from an analysis application, a first request to aggregate data of a given data source; in response to receiving the first request, retrieving new data from the given data source and retrieving historical data from a persistent data source corresponding to the given data source; aggregating only the new data from the given data source; combining the historical data with the aggregated new data in a first proxy data source; providing the first proxy data source as an input to the analysis application; and generating a view of results of an analysis of the first proxy data source and displaying the view in a user interface on a first computing device.
Example 18: The non-transitory computer readable storage medium of Example 17, wherein the operations further comprise overwriting the given data source with the first proxy data source.
Example 19: The non-transitory computer readable storage medium of any of Examples 17-18, wherein the operations further comprise: receiving, from the analysis application, a second request to aggregate data of the given data source; in response to receiving the second request, retrieving second new data from the given data source and retrieving second historical data from the overwritten given data source; aggregating only the second new data from the given data source; combining the second historical data with the aggregated second new data in a second proxy data source; and providing the second proxy data source as an input to an analysis application.
Example 20: The non-transitory computer readable storage medium of any of Examples 17-19, wherein the operations further comprise overwriting the given data source with the second proxy data source.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
at least one processor; and
at least one memory storing instructions that, when executed by the at least one processor, cause operations comprising:
receiving, from an analysis application, a first request to aggregate data of a given data source;
in response to receiving the first request, retrieving new data from the given data source and retrieving historical data from a persistent data source corresponding to the given data source;
aggregating only the new data from the given data source;
combining the historical data with the aggregated new data in a first proxy data source;
providing the first proxy data source as an input to the analysis application; and
generating a view of results of an analysis of the first proxy data source and displaying the view in a user interface on a first computing device.

2. The system of claim 1, wherein the operations further comprise overwriting the given data source with the first proxy data source.

3. The system of claim 2, wherein the operations further comprise:
receiving, from the analysis application, a second request to aggregate data of the given data source;
in response to receiving the second request, retrieving second new data from the given data source and retrieving second historical data from the overwritten given data source;
aggregating only the second new data from the given data source;
combining the second historical data with the aggregated second new data in a second proxy data source; and
providing the second proxy data source as an input to an analysis application.

4. The system of claim 3, wherein the operations further comprise overwriting the given data source with the second proxy data source.

5. The system of claim 1, wherein the operations further comprise determining one or more subsidiary database tables associated with the given data source.

6. The system of claim 1, wherein the historical data is stored in a first aggregation table.

7. The system of claim 6, wherein the operations further comprise adding, by an authorization check analysis unit, one or more fields to the first aggregation table, wherein the one or more fields are relevant for authorization checks.

8. The system of claim 7, wherein the operations further comprise generating a routine to fill the first aggregation table.

9. A computer-implemented method comprising:
receiving, from an analysis application, a first request to aggregate data of a given data source;
in response to receiving the first request, retrieving new data from the given data source and retrieving historical data from a persistent data source corresponding to the given data source;
aggregating only the new data from the given data source;
combining the historical data with the aggregated new data in a first proxy data source;
providing the first proxy data source as an input to the analysis application; and
generating a view of results of an analysis of the first proxy data source and displaying the view in a user interface on a first computing device.

10. The computer-implemented method of claim 9, further comprising overwriting the given data source with the first proxy data source.

11. The computer-implemented method of claim 10, further comprising:
receiving, from the analysis application, a second request to aggregate data of the given data source;
in response to receiving the second request, retrieving second new data from the given data source and retrieving second historical data from the overwritten given data source;
aggregating only the second new data from the given data source;
combining the second historical data with the aggregated second new data in a second proxy data source; and
providing the second proxy data source as an input to an analysis application.

12. The computer-implemented method of claim 11, further comprising overwriting the given data source with the second proxy data source.

13. The computer-implemented method of claim 9, further comprising determining one or more subsidiary database tables associated with the given data source.

14. The computer-implemented method of claim 9, wherein the historical data is stored in a first aggregation table.

15. The computer-implemented method of claim 14, further comprising adding, by an authorization check analysis unit, one or more fields to the first aggregation table, wherein the one or more fields are relevant for authorization checks.

16. The computer-implemented method of claim 15, further comprising generating a routine to fill the first aggregation table.

17. A non-transitory computer readable storage medium storing instructions, which when executed by at least one data processor, result in operations comprising:
receiving, from an analysis application, a first request to aggregate data of a given data source;
in response to receiving the first request, retrieving new data from the given data source and retrieving historical data from a persistent data source corresponding to the given data source;
aggregating only the new data from the given data source;
combining the historical data with the aggregated new data in a first proxy data source;
providing the first proxy data source as an input to the analysis application; and
generating a view of results of an analysis of the first proxy data source and displaying the view in a user interface on a first computing device.

18. The non-transitory computer readable storage medium of claim 17, wherein the operations further comprise overwriting the given data source with the first proxy data source.

19. The non-transitory computer readable storage medium of claim 18, wherein the operations further comprise:
receiving, from the analysis application, a second request to aggregate data of the given data source;
in response to receiving the second request, retrieving second new data from the given data source and retrieving second historical data from the overwritten given data source;
aggregating only the second new data from the given data source;
combining the second historical data with the aggregated second new data in a second proxy data source; and
providing the second proxy data source as an input to an analysis application.

20. The non-transitory computer readable storage medium of claim 19, wherein the operations further comprise overwriting the given data source with the second proxy data source.
